(19) United States
(12) Patent Application Publication
(10) Pub. No.: US 2015/0176995 A1
(43) Pub. Date: Jun. 25, 2015

(54) ANGULAR VELOCITY SENSOR

(71) Applicant: SAMSUNG ELECTRO-MECHANICS CO., LTD., Gyeonggi-Do (KR)

(72) Inventors: Jong Woon KIM, Gyeonggi-Do (KR); Jun LIM, Gyeonggi-Do (KR); Jai Hyoung GIL, Gyeonggi-Do (KR)

(73) Assignee: SAMSUNG ELECTRO-MECHANICS CO., LTD., Gyeonggi-Do (KR)

(21) Appl. No.: 14/574,586

(22) Filed: Dec. 18, 2014

(30) Foreign Application Priority Data
Dec. 20, 2013 (KR) 10-2013-0160579

(51) Int. Cl. G01C 19/5705

(52) U.S. Cl. CPC G01C 19/5705

(57) ABSTRACT

Embodiments of the invention provide an angular velocity sensor, including a mass body, a first frame disposed at an outside of the mass body, a first flexible part connecting the mass body to the first frame, and a second flexible part connecting the mass body to the first frame. The angular velocity sensor further includes a second frame disposed at the outside of the first frame, a third flexible part connecting the first frame to the second frame, and a fourth flexible part connecting the first frame to the second frame. According to at least one embodiment, the first flexible part is connected to be displaced depending on a movement of the mass body, the second flexible part is fixed to the first frame to rotatably displace the mass body, and the third flexible part is fixed to the second frame to rotatably displace the first frame and is formed in pair which is adjacent and opposite to each other.

### CROSS REFERENCE TO RELATED APPLICATION

This application claims the benefit of and priority under 35 U.S.C. §119 to Korean Patent Application No. KR 10-2013-0160579, entitled “ANGULAR VELOCITY SENSOR,” filed on Dec. 20, 2013, which is hereby incorporated by reference in their entirety into this application.

### BACKGROUND

1. Field of the Invention

The present invention relates to an angular velocity sensor.

2. Description of the Related Art

Recently, an angular velocity sensor has been used in various applications, for example, military, such as an artificial satellite, a missile, and an unmanned aircraft, vehicles, such as an air bag, electronic stability control (ESC), and a black box for a vehicle, hand shaking prevention of a camcorder, motion sensing of a mobile phone or a game machine, navigation, as non-limiting examples.

The angular velocity sensor generally adopts a configuration in which a mass body is adhered to an elastic substrate, such as a membrane, in order to measure angular velocity. Through the configuration, the angular velocity sensor may calculate the angular velocity by measuring Coriolis force applied to the mass body.

In detail, a scheme of measuring the angular velocity using the angular velocity sensor is as follows. First, the angular velocity may be measured by Coriolis force “F=2 mΩ×v”, where “F” represents the Coriolis force applied to the mass body, “m” represents the mass of the mass body, “Ω” represents the angular velocity to be measured, and “v” represents the motion velocity of the mass body. Since the motion velocity V of the mass body and the mass m of the mass body are values known in advance, the angular velocity Ω may be obtained by detecting the Coriolis force (F) applied to the mass body.

Meanwhile, a conventional angular velocity sensor includes a piezoelectric material disposed on a membrane (i.e., diaphragm) in order to drive the mass body or sense displacement of the mass body, as disclosed, for example, in U.S. Patent Publication No. 2011/0146404. In order to measure the angular velocity using the angular velocity sensor, it is preferable to allow a resonance frequency of a driving mode and a resonance frequency of a sensing mode to substantially coincide with each other. However, a very large interference between the driving mode and the sensing mode may occur due to a fine manufacturing error which is caused by shape/stress/physical property, and the like. Therefore, since a noise signal much larger than an angular velocity signal is output, a circuit amplification of the angular velocity signal is limited, such that sensitivity of the angular velocity sensor may be deteriorated.

### SUMMARY

Accordingly, embodiments of the invention have been made to provide an angular velocity sensor, in which a flexible part is provided with two frames to individually generate a driving displacement and a sensing displacement of a mass body and is formed to move a mass body only in a specific direction, thereby removing interference between a driving mode and a sensing mode and reducing an influence due to manufacturing errors and the flexible part of a driving unit side is formed in a pair of flexible parts to prevent a dispersion in a difference between resonance frequencies of the driving mode and the sensing mode from occurring, thereby improving sensitivity yield.

According to at least one embodiment, there is provided an angular velocity sensor, including a mass body, a first frame disposed at an outside of the mass body, a first flexible part connecting the mass body to the first frame, a second flexible part connecting the mass body to the first frame, a second frame disposed at the outside of the first frame, a third flexible part connecting the first frame to the second frame, and a fourth flexible part connecting the first frame to the second frame. According to at least one embodiment, the first flexible part is connected to be displaced depending on a movement of the mass body, the second flexible part is fixed to the first frame to rotatably displace the mass body, and the third flexible part is fixed to the second frame to rotatably displace the first frame and is formed in pair which is adjacent and opposite to each other.

According to at least one embodiment, the second flexible part connects the mass body to the first frame in a Y-axis direction and the third flexible part connects the first frame to the second frame in an X-axis direction.

According to at least one embodiment, the first flexible part connects the mass body to the first frame in an X-axis direction and the fourth flexible part connects the first frame to the second frame in a Y-axis direction.

According to at least one embodiment, the first flexible part connects the mass body to the first frame in an X-axis direction, the second flexible part connects the mass body to the first frame in a Y-axis direction, the third flexible part connects the first frame to the second frame in an X-axis direction, and the fourth flexible part connects the first frame to the second frame in a Y-axis direction.

According to at least one embodiment, the first flexible part is a beam, which has a predetermined thickness in a Z-axis direction and has a surface formed by an X-axis and a Y-axis and the first flexible part is formed so that a width w₁ in the Y-axis direction is larger than a thickness t₁ in the Z-axis direction.

According to at least one embodiment, the second flexible part is a hinge which has a predetermined thickness in the X-axis direction and has a surface formed by a Y-axis and a Z-axis and the second flexible part is formed so that a thickness t₂ in the Z-axis direction is larger than a width w₂ in the X-axis direction.

According to at least one embodiment, the third flexible part is a hinge which has a predetermined thickness in the Y-axis direction and has a surface formed by an X-axis and a Z-axis and the third flexible part is formed so that a thickness t₃ in the Z-axis direction is larger than a width w₃ in the Y-axis direction.

According to at least one embodiment, the fourth flexible part is a beam which has a predetermined thickness in a Z-axis direction and has a surface formed by an X-axis and a Y-axis and the fourth flexible part is formed so that a width w₄ in the X-axis direction is larger than a thickness t₄ in the Z-axis direction.

According to at least one embodiment, the first flexible part is subjected to a bending stress and the second flexible part is subjected to a torsion stress.

According to at least one embodiment, the fourth flexible part is subjected to a bending stress and the third flexible part is subjected to a torsion stress.

According to at least one embodiment, the second flexible part is disposed above a center of gravity of the mass body based on the Z-axis direction.

According to at least one embodiment, the second flexible part is disposed at a position corresponding to a center of gravity of the mass body based on the Y-axis direction.

According to at least one embodiment, the first flexible part and the second flexible part are formed to have the first frame connected to both sides or one side of the mass body.

According to at least one embodiment, the third flexible part and the fourth flexible part are formed to have and the second frame connected to both sides or one side the first frame.

According to at least one embodiment, the first flexible part or the second flexible part are provided with a sensing unit, which senses a displacement of the mass body.

According to at least one embodiment, the third flexible part or the fourth flexible part are provided with a driving unit, which drives the first frame.

According to at least one embodiment, the driving unit rotates the first frame based on an X-axis.

According to at least one embodiment, the second flexible part and the third flexible part have a torsion bar shape.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a perspective view of an angular velocity sensor according to an embodiment of the invention.

FIG. 2 is a plan view of the angular velocity sensor illustrated in FIG. 1 according to an embodiment of the invention.

FIG. 3 is a cross-sectional view of the angular velocity sensor taken along the line A-A′ of FIG. 2 according to an embodiment of the invention.

FIG. 4 is a cross-sectional view of the angular velocity sensor taken along the line B-B′ of FIG. 2 according to an embodiment of the invention.

FIG. 5 is a plan view illustrating a mass body and a movable direction of a first frame shown in FIG. 2 according to an embodiment of the invention.

FIG. 6 is a cross-sectional view illustrating a movable direction of the mass body illustrated in FIG. 3 according to an embodiment of the invention.

FIGS. 7A and 7B are cross-sectional views showing a process of rotating the mass body illustrated in FIG. 3 with respect to the first frame based on an axis connected to a second flexible part according to an embodiment of the invention.

FIG. 8 is a cross-sectional view illustrating the movable direction of the first frame illustrated in FIG. 4 according to an embodiment of the invention.

FIGS. 9A and 9B are cross-sectional views illustrating a process of rotating the first frame illustrated in FIG. 4 with respect to a the second frame based on an axis connected to a fourth flexible part according to an embodiment of the invention.

FIGS. 10A to 10D are use state diagrams schematically illustrating a process of allowing the angular velocity sensor according to the first preferred embodiment of the present invention to measure angular velocity according to an embodiment of the invention.

FIG. 11 is a perspective view schematically illustrating an angular velocity sensor according to another embodiment of the invention.

FIGS. 12A and 12B are schematic graphs for describing a principle and a concept of the angular velocity sensor according to an embodiment of the invention, in which FIG. 12A is a graph of one flexible part and FIG. 12B is a graph of a pair of flexible parts.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

Hereinafter, various embodiments of the present invention will be described in detail with reference to the accompanying drawings.

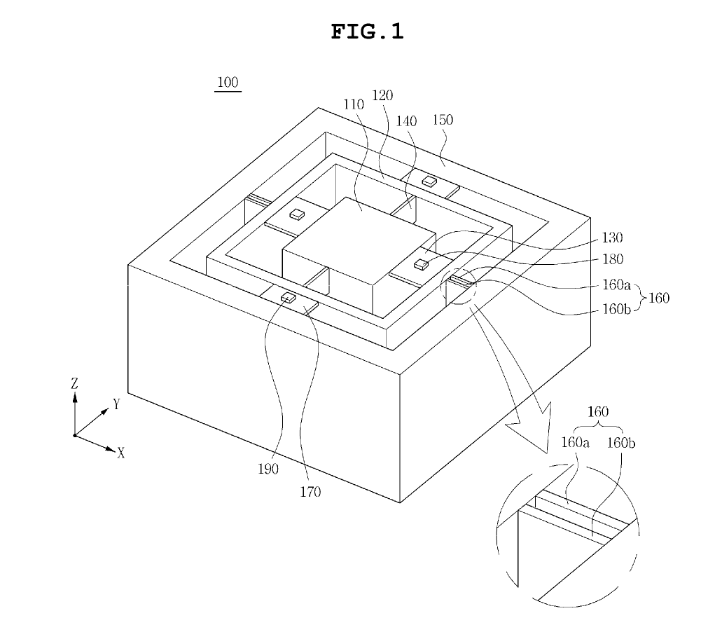

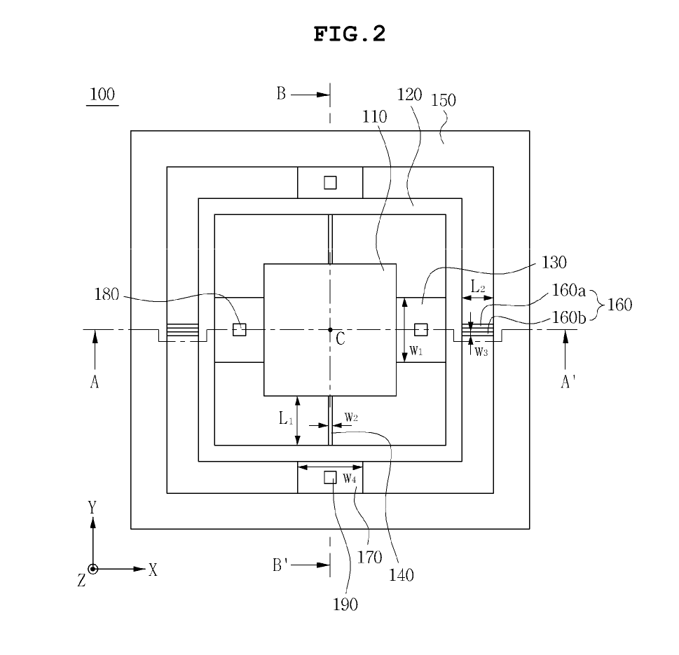

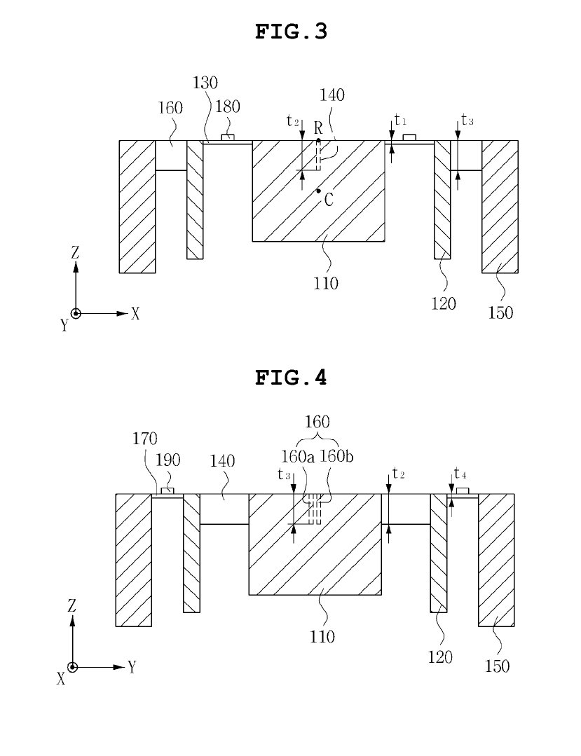

FIG. 1 is a perspective view of an angular velocity sensor according to an embodiment of the invention, FIG. 2 is a plan view of the angular velocity sensor illustrated in FIG. 1 according to an embodiment of the invention, FIG. 3 is a cross-sectional view of the angular velocity sensor taken along the line A-A′ of FIG. 2 according to an embodiment of the invention, and FIG. 4 is a cross-sectional view of the angular velocity sensor taken along the line B-B′ of FIG. 2 according to an embodiment of the invention.

As illustrated, an angular velocity sensor 100 includes a mass body 110, a first frame 120, a first flexible part 130, a second flexible part 140, a second frame 150, a third flexible part 160, and a fourth flexible part 170.

In more detail, the first frame 120 is disposed at an outside of the mass body 110 so as to be spaced apart from the mass body 110, the first flexible part 130 connects the mass body 110 to the first fame 120, the second flexible part 140 connects the mass body 110 to the first frame 120, the second frame 150 is disposed at an outside of the first frame 120 so as to be spaced apart from the first frame 120, the third flexible part 160 connects the first frame 120 to the second frame 150, and the fourth flexible part 170 connects the first frame 120 to the second frame 150.

Further, according to at least one embodiment, any one of the first flexible part 130 or the second flexible part 140 is fixed to the first frame 120 to rotatably displace the mass body 110 and the other thereof is connected thereto to be displaced depending on the movement of the mass body 110 and any one of the third flexible part 160 and the fourth flexible part 170 is fixed to the second frame 150 to rotatably displace the first frame 120.

According to at least one embodiment of the invention, the third flexible part 160 or the fourth flexible part 170, which is fixed to the second frame 150 to rotatably displace the first frame 120 is formed in a hinge and the third flexible part 160 or the fourth flexible part 170 formed in the hinge is formed in pair, which is opposite to each other.

According to at least one embodiment of the invention, any one of the first flexible part 130 and the second flexible 140 is provided with the sensing unit 130 and any one of the third flexible part 160 and the fourth flexible part 170 is provided with a driving unit 190.

Further, FIG. 1 is an embodiment thereof and illustrates that the first flexible part 130 is provided with a sensing unit 180 and the fourth flexible part 170 is provided with the driving unit 190. Further, the sensing unit 180 and the driving unit 190 are not particularly limited, but may be formed to use a piezoelectric type, a piezoresistive type, a capacitive type, an optical type, as non-limiting examples.

Hereinafter, functions, detailed shapes, and organic coupling of each component of the angular velocity sensor according to at least one embodiment of the invention will be described in detail.

According to at least one embodiment of the invention, the mass body 110, which is displaced, for example, by an inertial force, a Coriolis force, an external force, as non-limiting examples, is connected to the first frame 120 by the first flexible part 130 and the second flexible part 140 and is supported in a floating state to be able to be displaced by the first frame 120.

Further, the mass body 110 causes a rotating displacement based on the first frame 120 due to a bending displacement of the first flexible part 130 and a torsion displacement of the second flexible part 140 when the Coriolis force is applied thereto. In this case, the mass body 110 rotates with respect to the first frame 120 based on an axis to which the second flexible part 140 is connected. The detailed contents thereof will be described below. Meanwhile, although the mass body 110 may have a square pillar shape, the mass body 110 is not limited thereto, and therefore may have any shape known in the art.

Next, the first frame 120 supports the first flexible part 130 and the second flexible part 140 to secure a space in which the mass body 110 is displaced and is a reference when the mass body 110 is displaced. Further, the first frame 120 is disposed at an outside of the mass body 110 to be spaced apart from the mass body 110. In this case, the first frame 120 has a square pillar shape of which the center is formed with a cavity having a square pillar shape, but is not limited thereto.

Further, the first frame 120 is connected to the second frame 150 by the third and fourth flexible parts 160 and 170. Further, when the first frame 120 is driven by the driving unit 190 formed in the fourth flexible part 170, the first frame 120 is displaced by torsion of the third flexible part 160 and bending of the fourth flexible part 170 in the state in which the first frame 120 is connected to the second frame 150.

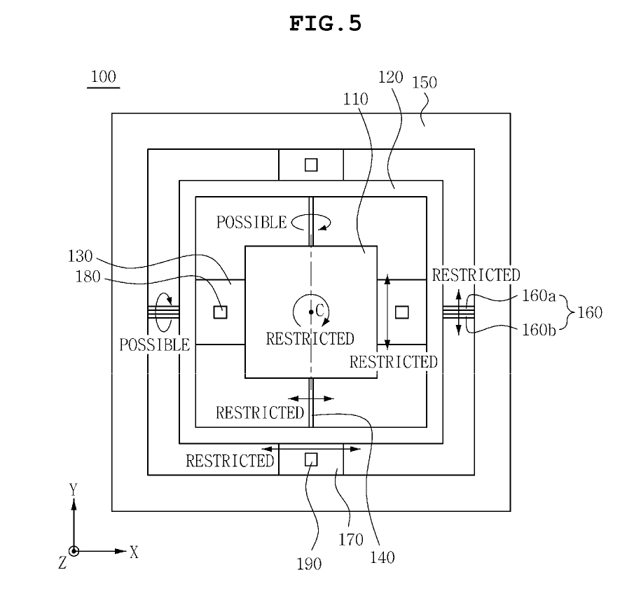

In this case, the first frame 120 rotates the second frame 150 based on the axis connected to the third flexible part 16, thus, the X-axis and the contents thereof will be described below in more detail with reference to FIG. 5.

Next, the first and second flexible parts 130 and 140 serve to connect the first frame 120 to the mass body 110, so that the mass body 110 is displaced based on the first frame 120. Further, as described above, any one of the first flexible part 130 and the second flexible part 140 is fixed to the first frame 120 to rotatably displace the mass body 110 and the other thereof is connected thereto to be displaced depending on the movement of the mass body 110. Further, the angular velocity sensor according to at least one embodiment of the invention is formed so that the second flexible part 140 serves as the hinge and the first flexible part 10 is subjected to the bending displacement.

According to at least one embodiment of the invention, the first flexible part 130 is a beam, which has a predetermined thickness in a Z-axis direction and is formed to have a surface formed by an X-axis and a Y-axis. According to at least one embodiment of the invention, the first flexible part 130 is formed so that a width w₁ in a Y-axis direction is larger than a thickness t₁ in the Z-axis direction.

According to at least one embodiment of the invention, the first flexible part 130 is provided with the sensing unit 180 as described above. Thus, when viewed from an XY plane, since the first flexible part 130 is relatively wider than the second flexible part 140, and therefore the first flexible part 130 is provided with the sensing unit 180, which senses the displacement of the mass body 110.

According to at least one embodiment of the invention, the second flexible part 140 is a hinge, which has a predetermined thickness in the X-axis direction and is formed to have a surface formed by the Y-axis and the Z-axis. Thus, the second flexible part 140 is formed so that a thickness t₂ in the Z-axis direction is larger than a width w₂ in the X-axis direction.

According to at least one embodiment of the invention, the second flexible part 140 has a torsion bar shape.

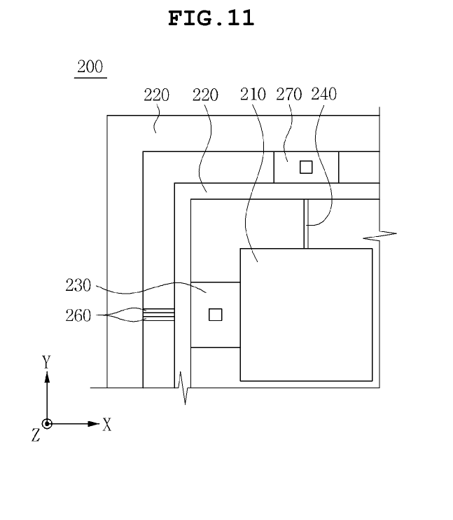

According to at least one embodiment of the invention, the first flexible part 130 and the second flexible part 140 are disposed in an orthogonal direction to each other. According to at least one embodiment of the invention, the first flexible part 130 connects the mass body 110 to the first frame 120 in the X-axis direction and the second flexible part 140 connects the mass body 110 to the first frame 120 in the Y-axis direction. In this case, the first flexible part 130 and the second flexible part 140 are each formed to have the mass body 110 and the first frame 120 connected to both sides thereof. However, as illustrated in FIG. 11, if necessary, a first flexible part 230 and a second flexible part 240 are each formed to have the mass body 210 and the first frame 220 connected only to one side thereof. Further, the third flexible part 260 and the fourth flexible part 270 are each formed to have the first frame 220 and the second frame 250 connected to both sides or one side thereof.

Meanwhile, components illustrated in FIG. 11 each correspond to the technical components illustrated in FIG. 2, and therefore the additional description thereof will be omitted.

According to at least one embodiment of the invention, as shown in FIGS. 2 to 4, in the first flexible part 130, the width w₁ in the Y-axis direction is larger than the thickness t₁ in the Z-axis direction and in the second flexible part 140, the thickness t₂ in the Z-axis direction is larger than the width w₂ in the X-axis direction. Due to characteristics of the first flexible part 130 and the second flexible part 140 as described above, the mass body 110 moves only in a specific direction with respect to the first frame 120.

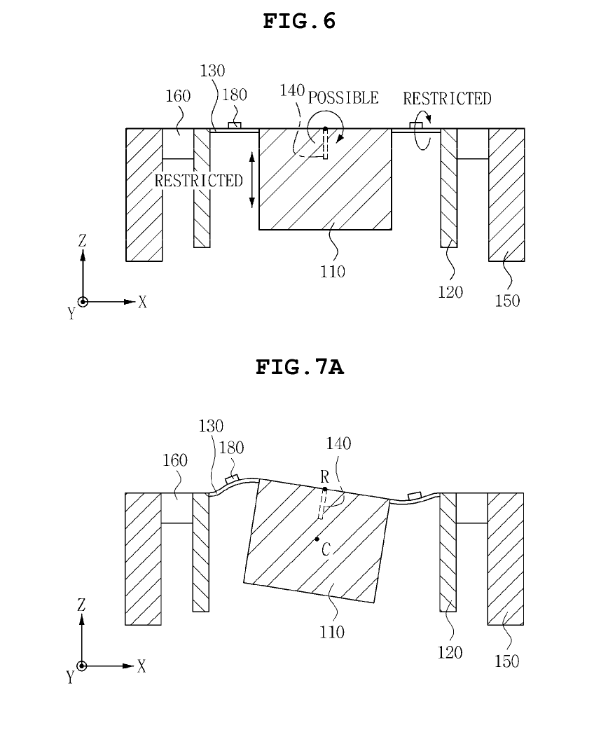

FIG. 5 is a plan view illustrating a mass body and a movable direction of a first frame shown in FIG. 2 and FIG. 6 is a cross-sectional view illustrating a movable direction of the mass body illustrated in FIG. 3 according to an embodiment of the invention. The movable direction of the mass body 110 will be described in more detail with reference to FIGS. 5 and 6.

According to at least one embodiment of the invention, the thickness t₂ in the Z-axis direction of the second flexible part 140 is larger than the width w₂ in the X-axis direction, and therefore the mass body 110 restrictively rotates with respect to the first frame 120 based on the X-axis or may be restrictively translated in the Z-axis direction, but may relatively freely rotate based on the Y-axis.

Thus, as stiffness when the second flexible part 140 rotates based on the X-axis is larger than stiffness when the second flexible part 140 rotates based on the Y-axis, the mass body 110 freely rotates based on the Y-axis, but restrictively rotates based on the X-axis.

Similarly thereto, as stiffness when the second flexible part 140 is translated in the Z-axis direction is larger than stiffness when the second flexible part 140 rotates based on the Y-axis, the mass body 110 freely rotates based on the Y-axis, but may be restrictively translated in the Z-axis direction.

Therefore, as a value of the second flexible part 140 (the stiffness when the second flexible part 140 rotates based on the X-axis or the stiffness when the second flexible part 140 is translated in the Z-axis direction)/(the stiffness when the second flexible part rotates based on the Y-axis) is increased, the mass body 110 freely rotates with respect to the first frame 120 based on the Y-axis, but restrictively rotates based on the X-axis or is restrictively translated in the Z-axis direction.

Referring to FIGS. 2 and 3, the relationship between the thickness t₂ in the Z-axis direction, a length L₁ in the Y-axis direction, and the width w₂ in the X-axis direction of the second flexible part 140 and the stiffness for each direction is arranged as follows.

(1) The stiffness when the second flexible part 140 rotates based on the X-axis or the stiffness when the second flexible part 140 is translated in the Z-axis direction ∝ w₂×t₂³/L₂³.

(2) The stiffness when the second flexible part 140 rotates based on the Y-axis becomes ∝ w₂³×t₂/L₁.

According to the above two Equations, the value of the second flexible part 140 (the stiffness when the second flexible part 140 rotates based on the X-axis or the stiffness when the second flexible part 140 is translated in the Z-axis direction)/(the stiffness when the second flexible part 140 rotates based on the Y-axis) is in proportion to (t₂/(w₂L₁))². However, in the second flexible part 140 according to at least one embodiment, the thickness t₂ in the Z-axis direction is larger than the width w₂ in the X-axis direction, and therefore (t_{2/(w}₂L₁))² is large, such that the value of the second flexible part 140 (the stiffness when the second flexible part 140 rotates based on the X-axis or the stiffness when the second flexible part 140 is translated in the Z-axis)/(the stiffness when the second flexible part 140 rotates based on the Y-axis) is increased. Due to the characteristics of the second flexible part 140, the mass body 110 freely rotates with respect to the first frame 120 based on the Y-axis, but restrictively rotates based on the X-axis or is restrictively translated in the Z-axis direction.

Meanwhile, since the longitudinal (X-axis directional) stiffness is relatively very high, the first flexible part 130 restricts the rotation of the mass body 110 with respect to the first frame 120 based on the Z-axis or the translation of the mass body 110 in the X-axis direction.

In addition, since the longitudinal (Y-axis directional) stiffness is relatively very high, the second flexible part 140 restricts the translation of the mass body 110 in the Y-axis direction with respect to the first frame 120.

Consequently, due to the characteristics of the first flexible part 130 and the second flexible part 140 as described above, the mass body 110 rotates with respect to the first frame 120 based on the Y-axis, but may restrictively rotate based on the X-axis or the Z-axis or is restrictively translated in the Z-axis, Y-axis, or X-axis direction. Thus, the movable directions of the mass body 110 are arranged as the following Table 1.

TABLE 1

| Movable directions of mass body | |
|---|---|
| (based on first frame) | Whether or not movement is possible |
| Rotation based on X-axis | Restricted |
| Rotation based on Y-axis | Possible |
| Rotation based on Z-axis | Restricted |
| Translation in X-axis direction | Restricted |
| Translation in Y-axis direction | Restricted |
| Translation in Z-axis direction | Restricted |

As described above, the mass body 110 rotates with respect to the first frame 120 based on the Y-axis but the movement thereof in the rest directions is restricted, such that the mass body 110 is displaced only by the force in the desired direction (the rotation based on the Y-axis).

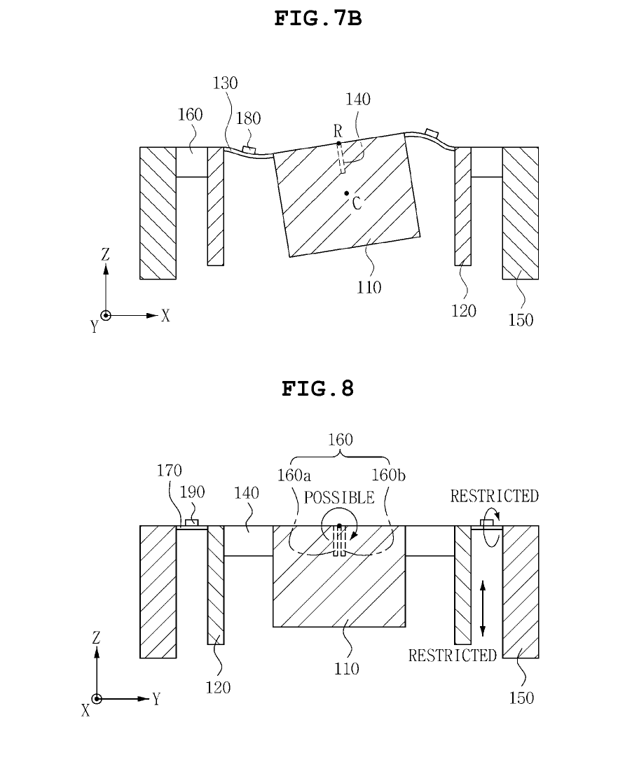

Meanwhile, FIGS. 7A and 7B are cross-sectional views showing a process of rotating the mass body illustrated in FIG. 3, according to an embodiment, with respect to the first frame based on an axis connected to the second flexible part. As illustrated, since the mass body 110 rotates with respect to the first frame 120 based on the Y-axis, which is an axis connected to the second flexible part 140, as a rotating axis R, the first flexible part 130 is subjected to a bending stress, which is a combination of a compression stress and a tensile stress and the second flexible part 140 is subjected to a torsion stress based on the Y-axis. In this case, in order to generate a torque in the mass body 110, the second flexible part 140 is disposed at a higher position than a center of gravity C of the mass body 110 based on the Z-axis direction.

In addition, as illustrated in FIG. 2, the second flexible part 140 may be disposed at a position corresponding to the center of gravity C of the mass body 110 based on the Y-axis direction so that the mass body 110 accurately rotates based on the Y-axis.

Next, the second frame 150 is connected to the first frame 120 by the third flexible part 160 and the fourth flexible part 170 and secures the space in which the first frame 120 is displaced. Further, the second frame 150 is disposed at the outside of the first frame 120 to be spaced apart from the first frame 120. In this case, the second frame 150 has a square pillar shape of which the center is formed with a cavity having a square pillar shape, but is not limited thereto.

Next, the third and fourth flexible parts 160 and 170 serve to connect the second frame 150 to the first frame 120 to displace the first frame 120 based on the second frame 150. Further, the third flexible part 160 and the fourth flexible part 170 are formed in an orthogonal direction to each other. Thus, the third flexible part 160 connects the first frame 120 to the second frames 150 in the X-axis direction, and the fourth flexible part 170 connects the first frame 120 to the second frames 150 in the Y-axis direction. In this case, the third flexible part 160 and the fourth flexible part 170 are each formed to have the first frame 120 and the second frame 150 connected to both sides thereof. However, as illustrated in FIG. 11, if necessary, the third flexible part 160 and the fourth flexible part 170 are each formed to have the first frame 120 and the second frame 150 connected only to one side thereof.

In more detail, as illustrated in FIGS. 2 to 4, the third flexible part 160 is a hinge, which has a predetermined thickness in the Y-axis direction and is formed to have a surface formed by the X-axis and the Z-axis. Further, in the third flexible part, the thickness t₃ in the Z-axis direction is larger than the width w₃ in the Y-axis direction.

Further, as illustrated in FIG. 1, the third flexible part 160 is formed in pair, which is opposite to each other. Thus, a pair of third flexible parts 160a and 160b has the same shape and is disposed to be spaced apart from each other at a predetermined interval and connects the first frame 120 to the second frame 150.

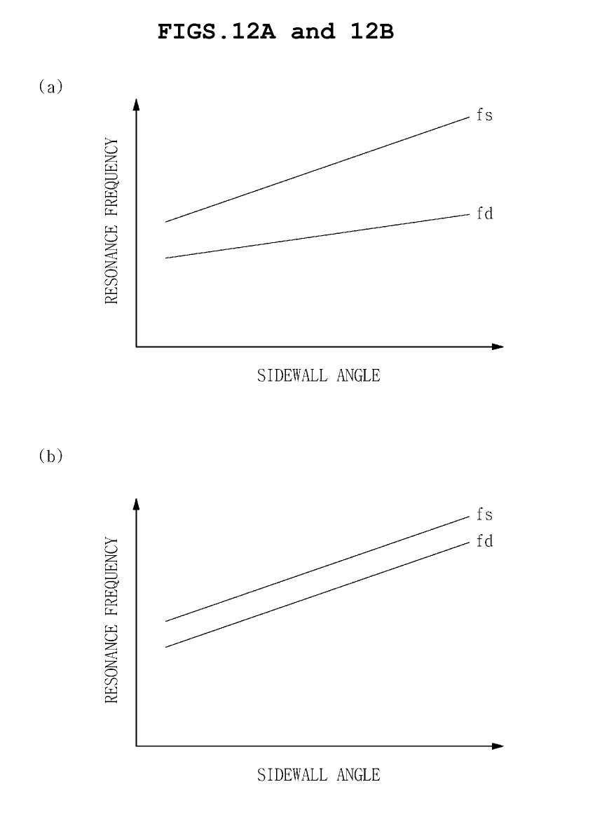

Hereinafter, a principle and a concept of forming the third flexible part of the angular velocity sensor according to at least one embodiment of the invention will be described in more detail with reference to FIGS. 12A and 12B.

FIGS. 12A and 12B are schematic graphs for describing a technical idea of the angular velocity sensor according to at least one embodiment of the invention, in which FIG. 12A is a graph of one flexible part and FIG. 12B is a graph of a pair of flexible parts.

In more detail, according to the angular velocity sensor which includes the frame to use the rotating motion as a resonance mode, shear stiffness of a driving side hinge which is the third flexible part and shear stiffness of a sensing side hinge which is the second flexible part determine the resonance frequencies of the driving mode and the sensing mode, respectively.

Thus, when w << t, the torsion stiffness of the hinge which has the width w, the thickness t, the length L, a shear modulus G is represented by K=G*t*(ŵ3)/(3L). Further, when intending to reduce the stiffness to implement the high sensitivity, the width w of the hinge may be designed to be small. Further, when the width w of the hinge is small, the shear stiffness of the hinge is sensitive to an etching process (DRIE sidewall angle) deviation.

According to at least one embodiment of the invention, the sensitivity of the angular velocity is inversely proportional to Δf(=fd−fs) and therefore in order to increase the sensitivity yield, there is a need to make the Δf deviation small. Herein, the driving side resonance frequency fd and the sensing side resonance frequency fs are each proportional to √(Kd/Id) and √(Ks/Is) (I is a mass moment of inertia of a resonance system).

According to at least one embodiment of the invention, since Id is generally larger than Is, Kd is designed to be larger than Ks to achieve Δf matching and a width wd of the driving side hinge is designed to be larger than a width ws of the sensing side hinge.

According to at least one embodiment of the invention, when the driving unit hinge and the sensing unit hinge are formed together by the etching process, a sidewall angle deviation changes the width wd of the driving side hinge and the width ws of the sensing side hinge to be similar to each other. Next, as illustrated in FIG. 12A, Ks and fs are changed to be more sensitive to the process deviation than Kd and fd. Therefore, when the Δf is insensitive to the process deviation, there is a need to similarly balance sensitivity of the fs by increasing sensitivity of the fd.

According to at least one embodiment of the invention, the angular velocity sensor obtains an effect of forming a cavity in a driving hinge by forming the third flexible part 160, which is the driving hinge, as the pair of flexible parts 160a and 160b and thus as illustrated in FIG. 12B, the predetermined etching process deviation changes the fd and fs to be the same quantity, such that the deviation in the difference between the resonance frequencies, which is Δf, does not occur.

According to at least one embodiment of the invention, the second flexible part 140 and the third flexible part 160 have a torsion bar shape.

Next, the fourth flexible part 170 is a beam, which has a predetermined thickness in the Z-axis direction and is formed to have a surface formed by the X-axis and the Y-axis. According to at least one embodiment of the invention, the fourth flexible part 170 is formed so that a width w₄ in the X-axis direction is larger than a thickness t₄ in the Z-axis direction. Due to these characteristics of the third and fourth flexible parts 160 and 170, the first frame 120 is movable only in a specific direction based on the second frame 150.

Hereinafter, the movable direction of the first frame 120 will be described with reference to FIGS. 5 and 8.

First, the thickness t₃ in the Z-axis direction of the third flexible part 160 is larger than the width w₃ in the Y-axis direction, and therefore the first frame 120 restrictively rotates with respect to the second frame 150 based on the Y-axis or is restrictively translated in the Z-axis direction, but may relatively freely rotate based on the X-axis.

In detail, as the stiffness when the third flexible part 160 rotates based on the Y-axis is larger than the stiffness when the third flexible part 140 rotates based on the X-axis, the first frame 120 freely rotates based on the X-axis, but restrictively rotates based on the Y-axis. Similarly thereto, as the stiffness when the third flexible part 160 is translated in the Z-axis direction is larger than the stiffness when the third flexible part 160 rotates based on the, the first frame 120 freely rotates based on the X-axis, but is restrictively translated in the Z-axis direction. Therefore, as the value of the third flexible part 160 (the stiffness when the third flexible part 160 rotates based on the Y-axis or the stiffness when the third flexible part 160 is translated in the Z-axis direction)/(the stiffness when the third flexible part 160 rotates based on the X-axis) is increased, the second frame 150 freely rotates with respect to the first frame 120 based on the X-axis, but restrictively rotates based on the Y-axis or is restrictively translated in the Z-axis direction.

Referring to FIGS. 2 to 4, the relationship between the thickness t₃ in the Z-axis direction, the length L₂ in the X-axis direction, and the width w₃ in the Y-axis direction of the third flexible part 160 and the stiffness for each direction is arranged as follows.

(1) The stiffness when the third flexible part 160 rotates based on the Y-axis or the stiffness when the third flexible part 160 is translated in the Z-axis direction ∝ w₃×t₃³/L₂³.

(2) The stiffness when the third flexible part 160 rotates based on the X-axis ∝0 w₃³×t₃/L₂.

According to the above two Equations, the value of the third flexible part 160 (the stiffness when the third flexible part 160 rotates based on the Y-axis or the stiffness when the third flexible part 160 is translated in the Z-axis direction)/(the stiffness when the third flexible part 160 rotates based on the X-axis) is in proportion to (t₃/(w₃L₂))². However, in the third flexible part 160 according to at least one embodiment, the thickness t₃ in the Z-axis direction is larger than the width w₃ in the Y-axis direction, and therefore (t₃/(w₃L₂))² is large, such that the value of the third flexible part 160 (the stiffness when the third flexible part rotates based on the Y-axis or the stiffness when the flexible part is translated in the Z-axis direction)/(the stiffness when the third flexible part rotates based on the X-axis) is increased. Due to the characteristics of the third flexible part 160, the first frame 120 freely rotates with respect to the second frame 150 based on the X-axis, but restrictively rotates based on the Y-axis or is restrictively translated in the Z-axis direction.

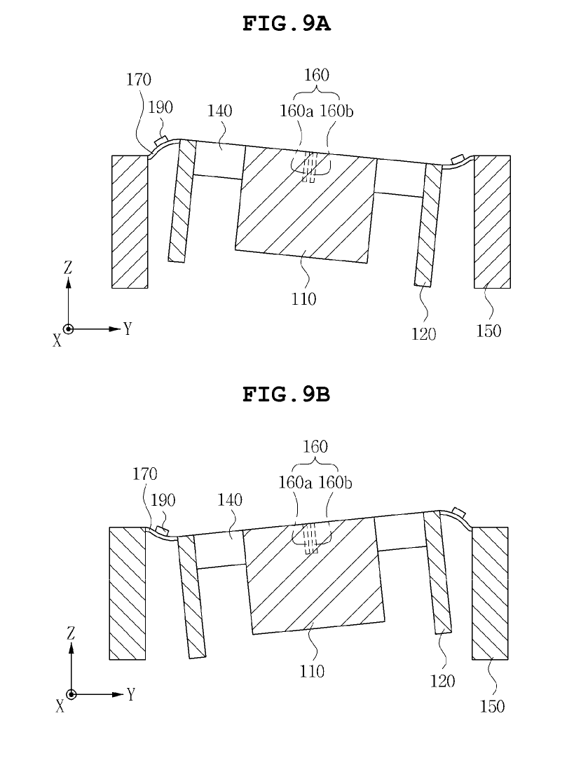

Meanwhile, since the longitudinal (Y-axis directional) stiffness is relatively very high, the fourth flexible part 170 may restrict the rotation of the first frame 120 with respect to the second frame 150 based on the Z-axis or the translation of the first frame 120 in the Y-axis direction (see FIG. 9). Further, since the longitudinal (X-axis directional) stiffness is relatively very high, the third flexible part 160 may restrict the translation of the first frame 120 with respect to the second frame 150 in the X-axis direction.

Consequently, due to the characteristics of the third flexible part 160 and the fourth flexible part 170 as described above, the first frame 120 rotates with respect to the second frame 150 based on the X-axis, but restrictively rotates based on the Y-axis or the Z-axis or is restrictively translated in the Z-axis, Y-axis, or X-axis direction. That is, the movable directions of the first frame 120 are arranged as the following Table 2.

TABLE 2

| Movable direction of first frame | |
|---|---|
| (based on second frame) | Whether or not movement is possible |
| Rotation based on X-axis | Possible |
| Rotation based on Y-axis | Restricted |
| Rotation based on Z-axis | Restricted |
| Translation in X-axis direction | Restricted |
| Translation in Y-axis direction | Restricted |
| Translation in Z-axis direction | Restricted |

As described above, the first frame 120 rotates with respect to the second frame 150 based on the X-axis, but the movement thereof in the rest directions is restricted, such that the first frame 120 is displaced only by the force in the desired direction (the rotation based on the X-axis).

FIGS. 9A and 9B are cross-sectional views illustrating a process of rotating the first frame illustrated in FIG. 4 with respect to a the second frame based on an axis connected to a fourth flexible part.

As illustrated in FIGS. 9A and 9B, since the first frame 120 rotates with respect to the second frame 150 based on the X-axis, the third flexible part 160 is subjected to the torsion stress based on the X-axis and the fourth flexible part 170 is subjected to the bending stress which is a combination of the compression stress and the tensile stress.

According to at least one embodiment of the invention, the driving unit 190 is selectively formed on the third flexible part 160 and the fourth flexible part 170 and as described above, as the one embodiment of the present invention, is formed on one surface of the third flexible part 160. Thus, when viewed from the XY-plane, since the third flexible part 160 is relatively wider than the fourth flexible part 170, the third flexible part 160 is provided with the driving unit 190, which drives the internal frame 120. Further, the driving unit 190 rotates the internal frame 120 based on the X-axis and is formed to use, for example, a piezoelectric type, a capacitive type, as non-limiting examples, without being particularly limited.

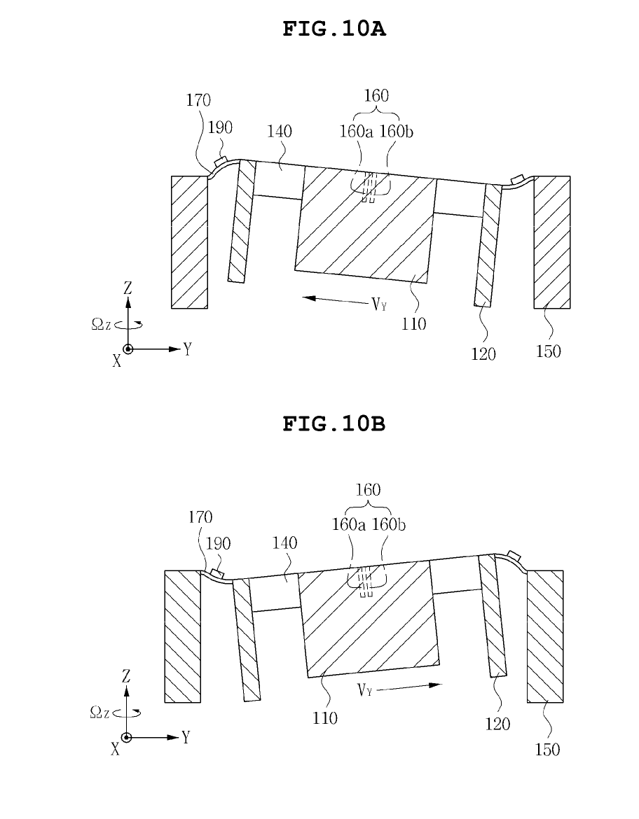

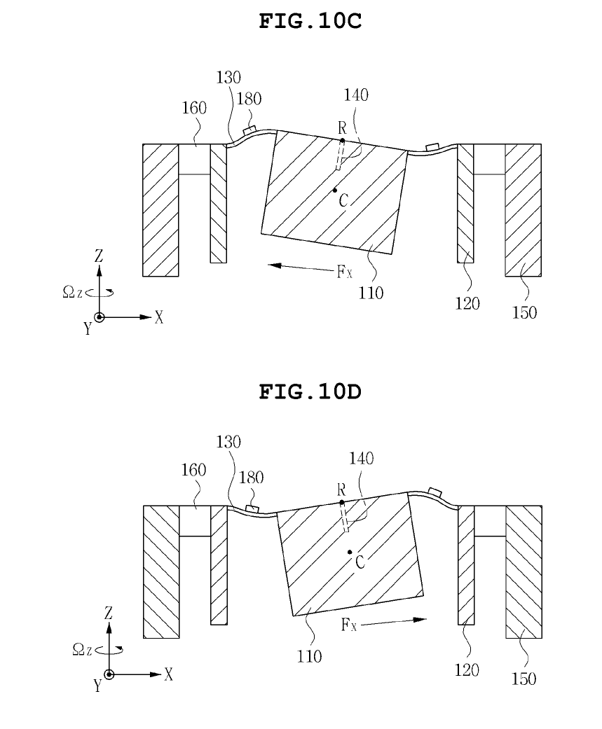

Meanwhile, the angular velocity sensor 100 according to at least one embodiment of the invention measures the angular velocity by using the foregoing structural characteristics. FIGS. 10A to 10D are use-state diagrams schematically illustrating a process of allowing the angular velocity sensor according to at least one embodiment of the invention to measure angular velocity; A process of measuring the angular velocity will be described in detail with reference to FIGS. 10A to 10D.

First, as illustrated in FIGS. 10A and 10B, the first frame 120 rotates with respect to the second frame 150 based on the X-axis by using the driving unit 190 (driving mode). In this case, the mass body 110 vibrates while rotating based on the—axis along with the first frame 120 and due to the vibration, a velocity V_{Y} is generated in the mass body 110 in the Y-axis direction. Further, when an angular velocity Ω_{Z} based on the Z-axis is applied to the mass body 110, a Coriolis force F_{X} is generated in the X-axis direction.

By the Coriolis force F_{X}, as illustrated in FIGS. 10C and 10D, the mass body 110 is displaced while rotating with respect to the first frame 120 based on the Y-axis and the sensing unit 180 senses the displacement of the mass body 110 (sensing mode). The Coriolis force F_{X} is calculated by sensing the displacement of the mass body 110 and the angular velocity Ω_{Z} based on the Z-axis is measured based on the Coriolis force F_{X} .

Meanwhile, due to the characteristics of the first flexible part 130 and the second flexible part 140 as described above, the mass body 110 rotates with respect to the first frame 120 only based on the Y-axis. Therefore, as illustrated in FIGS. 10A and 10B, even though the first frame 120 rotates with respect to the second frame 150 based on the X-axis by using the driving unit 190, the mass body 110 does not rotate the first frame 120 based on the Xaxis.

Further, due to these characteristics of the third and fourth flexible parts 160 and 170 as described above, the first frame 120 rotates with respect to the second frame 150 only based on the X-axis. Therefore, as illustrated in FIGS. 10C and 10D, when the displacement of the mass body 110 is sensed by using the sensing unit 180, even though the Coriolis force F_{X} in the X-axis direction is applied, the first frame 120 does not rotate with respect to the second frame 150 based on the Y-axis and only the mass body 110 rotates with respect to the first frame 120 in the Y-axis direction.

By the above configuration, the angular velocity sensor 100 according to at least one embodiment of the invention includes the first frame 120 and the second frame 150 to individually generate the driving displacement and the sensing displacement of the mass body 110 and forms the first, second, third, and fourth flexible parts 130, 140, 160, and 170, so that the mass body 110 and the first frame 120 may move only in the specific direction. Therefore, the sensitivity is improved due to the increase in the circuit amplification ratio by removing the interference between the driving mode and the sensing mode and the yield should be improved by reducing the influence due to the manufacturing error.

According to the at least one embodiment, the flexible part are provided with two frames to individually generate the driving displacement and the sensing displacement of the mass body and formed to move the mass body only in the specific direction. Therefore, it is possible to improve the sensitivity due to the increase in the circuit amplification ratio by removing the interference between the driving mode and the sensing mode, improve the yield by reducing the influence due to the manufacturing error, and improve the sensitivity yield by preventing the dispersion of the difference in the resonance frequency between the driving mode and the sensing mode from occurring by forming the flexible part of the driving unit side in the pair of flexible parts.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. An angular velocity sensor, comprising:
a mass body;
a first frame disposed at an outside of the mass body;
a first flexible part connecting the mass body to the first frame;
a second flexible part connecting the mass body to the first frame;
a second frame disposed at the outside of the first frame;
a third flexible part connecting the first frame to the second frame; and
a fourth flexible part connecting the first frame to the second frame,
wherein the first flexible part is connected to be displaced depending on a movement of the mass body,
wherein the second flexible part is fixed to the first frame to rotatably displace the mass body, and
wherein the third flexible part is fixed to the second frame to rotatably displace the first frame and is formed in pair which is adjacent and opposite to each other.

2. The angular velocity sensor as set forth in claim 1, wherein the second flexible part connects the mass body to the first frame in a Y-axis direction, and the third flexible part connects the first frame to the second frame in an X-axis direction.

3. The angular velocity sensor as set forth in claim 1, wherein the first flexible part connects the mass body to the first frame in an X-axis direction, and the fourth flexible part connects the first frame to the second frame in a Y-axis direction.

4. The angular velocity sensor as set forth in claim 1, wherein the first flexible part connects the mass body to the first frame in an X-axis direction, the second flexible part connects the mass body to the first frame in a Y-axis direction, the third flexible part connects the first frame to the second frame in an X-axis direction, and the fourth flexible part connects the first frame to the second frame in a Y-axis direction.

5. The angular velocity sensor as set forth in claim 4, wherein the first flexible part is a beam which has a predetermined thickness in a Z-axis direction and has a surface formed by an X-axis and a Y-axis and the first flexible part is formed so that a width w₁ in the Y-axis direction is larger than a thickness t₁ in the Z-axis direction.

6. The angular velocity sensor as set forth in claim 4, wherein the second flexible part is a hinge which has a predetermined thickness in the X-axis direction and has a surface formed by a Y-axis and a Z-axis and the second flexible part is formed so that a thickness t₂ in the Z-axis direction is larger than a width w₂ in the X-axis direction.

7. The angular velocity sensor as set forth in claim 4, wherein the third flexible part is a hinge which has a predetermined thickness in the Y-axis direction and has a surface formed by an X-axis and a Z-axis and the third flexible part is formed so that a thickness t₃ in the Z-axis direction is larger than a width w₃ in the Y-axis direction.

8. The angular velocity sensor as set forth in claim 4, wherein the fourth flexible part is a beam, which has a predetermined thickness in a Z-axis direction and has a surface formed by an X-axis and a Y-axis and the fourth flexible part is formed so that a width w₄ in the X-axis direction is larger than a thickness t₄ in the Z-axis direction.

9. The angular velocity sensor as set forth in claim 4, wherein the first flexible part is subjected to a bending stress and the second flexible part is subjected to a torsion stress.

10. The angular velocity sensor as set forth in claim 4, wherein the fourth flexible part is subjected to a bending stress and the third flexible part is subjected to a torsion stress.

11. The angular velocity sensor as set forth in claim 6, wherein the second flexible part is disposed above a center of gravity of the mass body based on the Z-axis direction.

12. The angular velocity sensor as set forth in claim 6, wherein the second flexible part is disposed at a position corresponding to a center of gravity of the mass body based on the Y-axis direction.

13. The angular velocity sensor as set forth in claim 1, wherein the first flexible part and the second flexible part are formed to have the first frame connected to both sides or one side of the mass body.

14. The angular velocity sensor as set forth in claim 1, wherein the third flexible part and the fourth flexible part are formed to have the second frame connected to both sides or one side of the first frame.

15. The angular velocity sensor as set forth in claim 1, wherein the first flexible part or the second flexible part is provided with a sensing unit, which senses a displacement of the mass body.

16. The angular velocity sensor as set forth in claim 1, wherein the third flexible part or the fourth flexible part is provided with a driving unit, which drives the first frame.

17. The angular velocity sensor as set forth in claim 16, wherein the driving unit rotates the first frame based on an X-axis.

18. The angular velocity sensor as set forth in claim 1, wherein the second flexible part and the third flexible part have a torsion bar shape
